(19) United States
(12) Patent Application Publication
(10) Pub. No.: US 2006/0092125 A1
(43) Pub. Date: May 4, 2006

(54) Apparatus and method to authenticate local interface for network attached projector

(76) Inventors: Richard V. Kisley, Tucson, AZ (US); John M. Lake, Cary, NC (US)

Correspondence Address: Dale F. Regelman;Law Office of Dale F. Regelman, P.C., 4231 S. Fremont Avenue, Tucson, AZ, 85714, US

(21) Appl. No.: 10/955,851

(22) Filed: Sep. 30, 2004

(51) Int. Cl. G09G 5/00

(52) U.S. Cl. 345/156

(57) ABSTRACT

A method is disclosed to authenticate a local interface for a network attached projector. The method provides a projector, an information storage medium comprising first information, and a communication link capable of communicating with the projector and with the information storage medium. The method defines access rights for the first information. Upon receiving a request for access to the first information from the projector, the method determines if the requestor has access rights to the first information. If the method determines that the requester has access rights to the first information, then the method provides the first information to the projector. Alternatively, if the method determines that the requestor does not have access rights to the first information, then the method denies access to the first information.

### FIELD OF THE INVENTION

The invention relates to a method and apparatus to authenticate a local interface for a network attached projector.

### BACKGROUND OF THE INVENTION

In the course of business, it is often necessary to give a live presentation using a projecting device, where that live presentation includes disclosing confidential information. It is often undesirable to recite such confidential information on one or more tangible objects, such as for example overhead transparencies, slides, and the like. In the event the content of such confidential information is revised, it may be difficult to update those tangible objects “on the road.” Moreover, proper disposal of the superceded objects may be difficult or impossible. In addition, safeguarding the security of those tangible objects, original, updated, superceded, and the like, remains a continuing burden.

Using a projector capable of accessing such confidential information via a communication link addresses many of the problems inherent with preparing and using tangible objects that recite such confidential information. What is needed, however, is an apparatus and method to authenticate a local interface for a network attached projector.

### SUMMARY OF THE INVENTION

Applicants' invention includes a method to authenticate a local interface for a network attached projector. The method provides a projector which includes a light projecting device, a processor interconnected with that light projecting device, a network interface interconnected with the processor, a non-volatile memory device interconnected with the processor, and microcode written to the memory device. The method further provides an information storage medium comprising first information and a communication link capable of communicating with the projector and with the information storage medium.

The method defines access rights for the first information. Subsequently, a requestor makes a request for access to the first information via the projector. The method determines if the requestor has access rights to the first information. If the method determines that the requestor has access rights to the first information, then the method provides the first information to the projector. Alternatively, if the method determines that the requestor does not have access rights to the first information, then the method denies access to the first information.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram of Applicants' projector;

FIG. 2 is a block diagram of a first embodiment of Applicants' network;

FIG. 3 is a block diagram of a second embodiment of Applicants' network;

FIG. 4 is a block diagram of a third embodiment of Applicants' network;

FIG. 5 is a flow chart summarizes the steps of Applicants' method; and

FIG. 6 is a flow chart summarizing certain additional steps of Applicants' method.

### DETAILED DESCRIPTION OF THE PREFERRED EMBODIMENTS

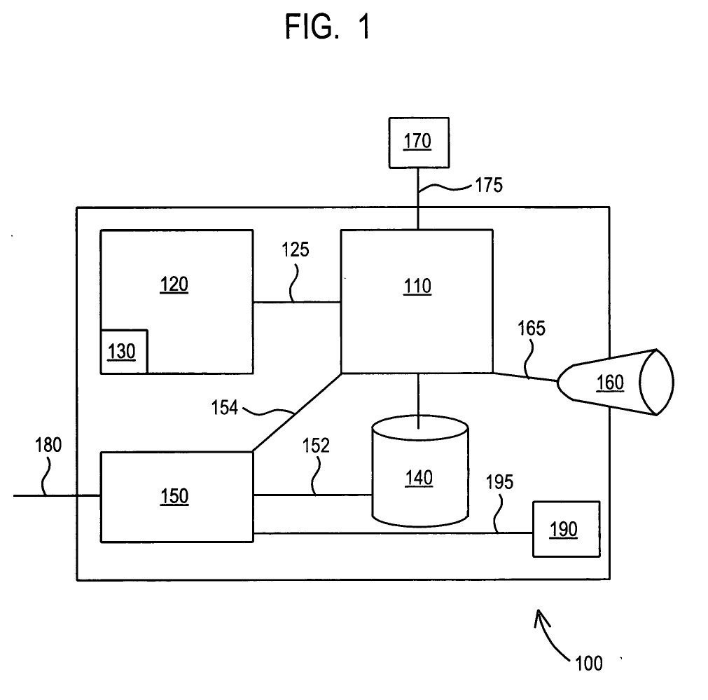

This invention is described in preferred embodiments in the following description with reference to the Figures, in which like numbers represent the same or similar elements. Referring now to FIG. 1, Applicant's projector 100 includes processor 110, memory 120, data cache 140, network interface 150, and light projecting device 160. Light projecting device 160 comprises an assembly which includes one or more light emitting devices, one or more optical lenses, and associated hardware, software, and circuitry to receive a signal from processor 110 via communication link 165, and then form and project a visible image based upon that signal.

Processor 110 is interconnected with memory 120, data cache 140, and network interface 150 via communication links 125, 145, and 154, respectively. In certain embodiments, data cache is interconnected with network interface 150 via communication link 152.

In certain embodiments, projector 100 further includes global positioning satellite (“GPS”) device 190. By “GPS device,” Applicants mean a device capable of receiving a plurality of signals from a plurality of GPS satellites, in combination with associated hardware, software, and circuitry to determine the geographical position of the device using that plurality of received signals.

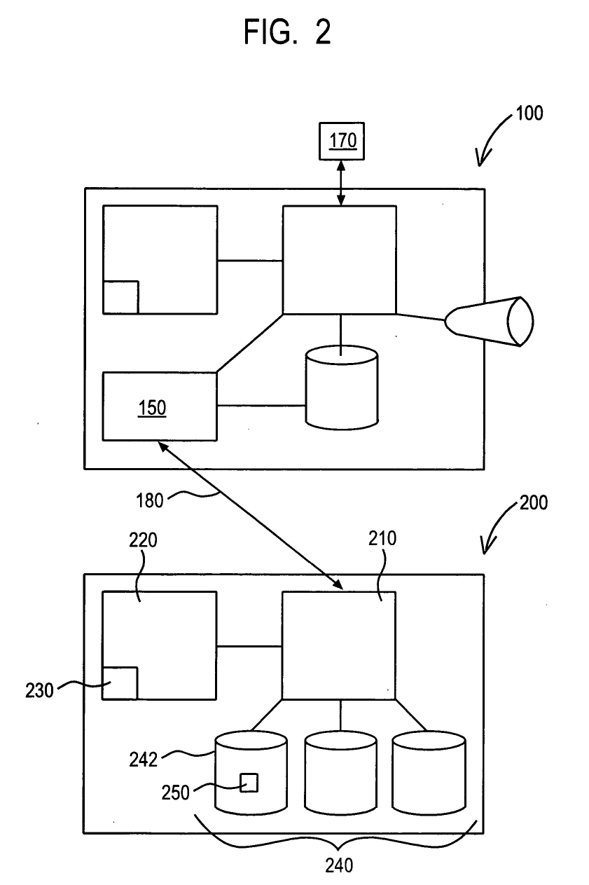

Referring to FIGS. 1 and 2, network interface 150 is interconnected with one or more computing devices via communication link 180. Communication link 180 is selected from the group comprising a wireless communication link, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In certain embodiments, communication link 180 is compliant with one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for example projector 100, and a base station or between two wireless clients. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or Wi-Fi, which comprises an extension to 802.11 that applies to wireless LANS and provides up to about 11 Mbps transmission in the 2.4 GHz band; and/or (iv) specification 802.11 g which applies to wireless LANs and provides 20+ Mbps in the 2.4 GHz band.

In certain embodiments, memory 120 comprises non-volatile memory, such as for example one or more EEPROMs (Electrically Erasable Programmable Read Only Memory), one or more flash PROMs (Programmable Read Only Memory), battery backup RAM, hard disk drive, one or more optical storage media (CD, DVD, and the like), combinations thereof, and the like.

Projector 100 further includes instructions/functions 130, written to memory 120. Processor 110 uses those instructions/functions to operate the projector. In certain embodiments, instructions/functions 130 comprise microcode specific to projector 100. .In other embodiments, instructions/functions 130 comprise a first operating system. By “operating system,” Applicant means, where certain of those instructions/functions are disposed in a user mode portion and where other of those instructions/functions are disposed in a kernel mode portion. As those skilled in the art will appreciate, user applications may invoke certain functions disposed in the user mode portion, but may not, without receiving authorization, access functions disposed in the kernel mode portion.

In certain embodiments, projector 100 further includes data input device 170. In certain embodiments, data input device 170 comprises a computing device which includes a monitor, keyboard, a second operating system, and the like. In certain embodiments, the first operating system and the second operating system are the same. In other embodiments, the first operating system differs from the second operating system.

In certain embodiments, data input device 170 comprises a hand-held device which includes a plurality of individual touch screens, buttons, switches, and the like, with which an operator can control certain functions of projector 100. For example, in one embodiment device 170 comprises a hand-held device with which an operator can instruct projector 100 to display a desired image.

Referring now to FIG. 2, in certain embodiments projector 100 is capable of communicating with computing device 200 via communication link 180. In certain embodiments, computing device 200 includes, without limitation, a processor 210, memory 220, operating system 230, and a plurality of information storage media 240 in combination with associated information storage devices. In certain embodiments, information storage media 240 include, without limitation hard disks disposed in hard disk drives, portable cassettes comprising magnetic tape storage media and the associated tape drive units, optical storage media and the associated optical disk drive units, RAM, DASDs, combinations thereof, and the like.

In certain embodiments of Applicant's apparatus and method, computing device 200 includes a unique directory, such as directory 250. By “unique,” Applicant means a directory to which access is controlled. In certain embodiments, access to such a unique directory is password controlled. In certain embodiments, access to such a unique directory is temporally controlled, such that access to that directory may only be granted within a specified time period. In certain embodiments, access to such a unique directory is geographically controlled, such that access may only be granted to a request originating from a specified location, wherein that specified location comprises a geographical place and/or a network address. As an example, in certain embodiments access to directory 250 will only be granted if the request for access includes an authorized password, and where the request originates from a designated TCP/IP address, and where the request originates from a designated geographical place, and where the request originates within a designed time period. Further as an example, if a requestor using Applicants' projector 100 comprising the designated TCP/IP address, makes a request using the designated password, from the designated geographical place, within the designated time interval, then access to the directory will be allowed.

In certain embodiments, the request is made using an LDAP directory structure. As those skilled in the art will appreciate, “LDAP” stands for Lightweight Directory Access Protocol. As the name suggests, this methodology comprises a lightweight client-server protocol for accessing directory services, specifically X.500-based directory services. LDAP runs over TCP/IP or other connection oriented transfer services. LDAP is defined in RFC2251 “The Lightweight Directory Access Protocol (v3).”

A directory is similar to a database, but tends to contain more descriptive, attribute-based information. The information in a directory is generally read much more often than it is written. Directories are tuned to give quick-response to high-volume lookup or search operations. They may have the ability to replicate information widely in order to increase availability and reliability, while reducing response time. When directory information is replicated, temporary inconsistencies between the replicas may be acceptable, as long as they are synchronized eventually.

As those skilled in the art will further appreciate, many different ways exist to provide a directory service. Different methods allow different kinds of information to be stored in the directory, place different requirements on how that information can be referenced, queried and updated, how it is protected from unauthorized access, etc. Some directory services are local, providing service to a restricted context (e.g., the finger service on a single machine). Other services are global, providing service to a much broader context.

LDAP directory service is based on a client-server model. One or more LDAP servers contain the data making up the LDAP directory tree or LDAP backend database. An LDAP client, such as for example projector 100, connects to an LDAP server, such as server 200, and makes a request. The server provides, for example, the requested information, or with a pointer to where the client can get more information (typically, another LDAP server). No matter what LDAP server a client connects to, that client “sees” the same view of the directory; a name presented to one LDAP server references the same entry it would at another LDAP server.

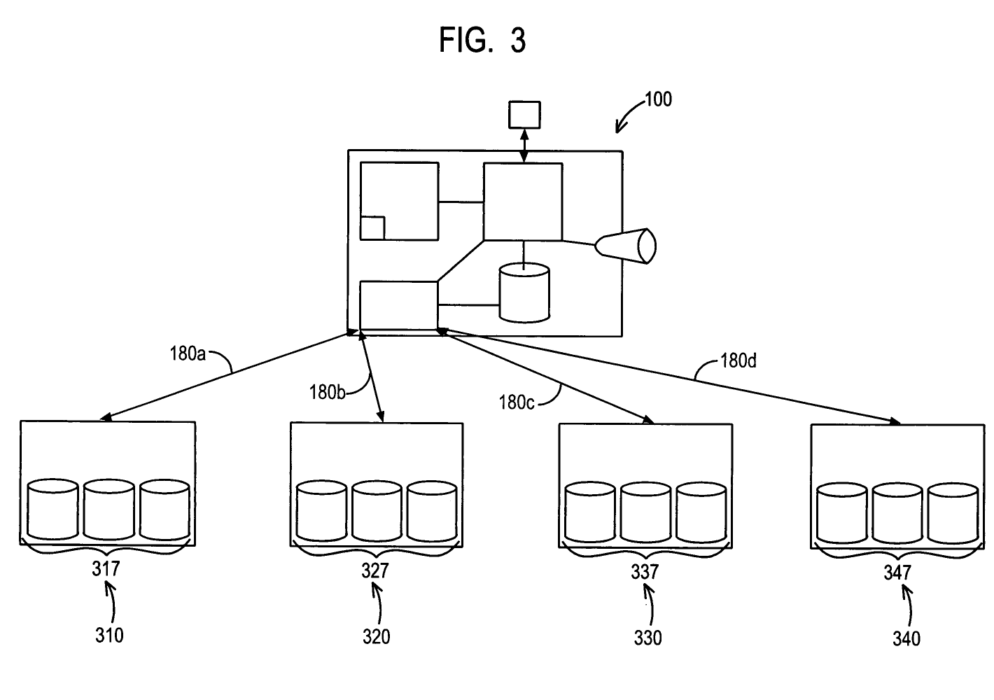

Referring now to FIG. 3, in certain embodiments Applicant's apparatus includes a plurality of servers, such as for example servers 310, 320, 330, and 340, wherein those servers include plurality of storage media/storage devices 317, 327, 337, and 347, respectively, where those storage media/storage devices are as described above with respect to storage media/storage device 240 (FIG. 2). In certain embodiments, one or more of servers 310, 320, 330, and 340, comprise computing devices. In certain embodiments, those one or more computing devices comprise computing device 200 (FIG. 2).

Server 310 is capable of communicating with Applicant's projector 100 (FIG. 1) via communication link 180a. Server 320 is capable of communicating with Applicant's projector 100 via communication link 180b. Server 330 is capable of communicating with Applicant's projector 100 via communication link 180c. Server 340 is capable of communicating with Applicant's projector 100 via communication link 180d. The illustrated embodiment of FIG. 3 shows four servers capable of communicating with projector 100. In other embodiments, Applicants' apparatus includes fewer than four servers capable of communicating with projector 100. In still other embodiments, Applicants' apparatus includes more than four servers capable of communicating with projector 100.

Communication links 180a, 180b, 180c, 180d, are each independently selected from the group which includes a wireless communication link, a wireless communication link compliant with the IEEE Specification, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof. In certain embodiments of Applicant's apparatus and method, projector 100 (FIG. 1) communicates with servers 310, 320, 330, and/or 340, using LDAP, wherein one or more of plurality of storage media/storage devices 317, 327, 337, and/or 347, comprise one or more “unique” directories, as described above.

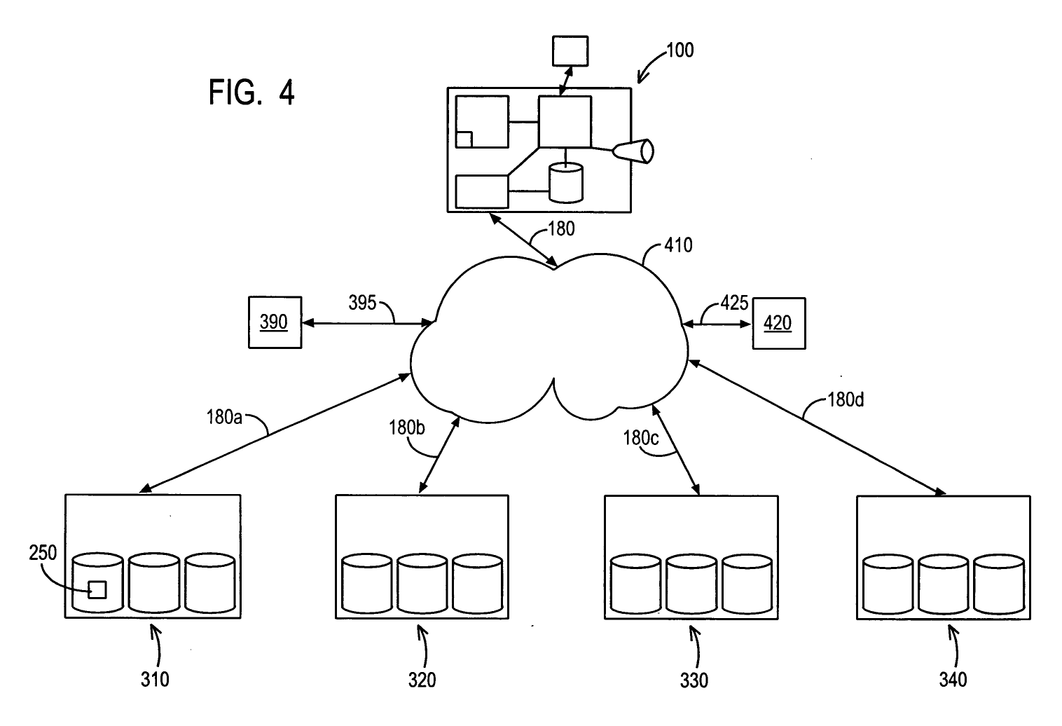

Referring now to FIG. 4, in certain embodiments Applicants' apparatus includes projector 100 (FIGS. 1, 2, 3, 4), server 310 (FIGS. 3, 4), server 320 (FIGS. 3, 4), server 330 (FIGS. 3, 4), and server 340 (FIGS. 3, 4), storage attached network (“SAN”) 410, and computing device 390. In certain embodiments, computing device 390 comprises what is sometimes referred to as a host computer. Computing device 390 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; LINUX is a registered trademark owned by Linus Torvalds.) In certain embodiments, computing device 390 further includes a storage management program. The storage management program in the computing device 390 may include the functionality of storage management type programs known in the art that manage the transfer of data to and or from servers 310, 320, 330, and/or 340, and to and/or from projector 100, such as the IBM DFSMS implemented in the IBM MVS operating system

As those skilled in the art will appreciate, a SAN comprises a dedicated network that connects one or more hosts, such as computing device 390, one or more projectors, such as projector 100, and one or more storage devices and subsystems, such as servers 310, 320, 330, and/or 340. In certain embodiments, SAN 410 includes an appliance, such as a networked attached storage device (“NASD”) 420.

NASD 420 comprises storage elements or devices that connect to a network and provide file access services to, for example, projector 100. NASD 420 attaches directly to networks, such as local area networks, using traditional protocols such as Ethernet and TCP/IP, and serve files to one or more clients, such as for example projector 100, connected to the network. In certain embodiments, NASD 420 includes an engine, which implements the file access services. A client that accesses a NASD typically uses a file system device driver to access the stored data. The file system device driver typically implements file access commands. The file system driver disposed in a NASD interprets these commands and performs the internal device input/output (I/O) operations necessary to execute those file access commands.

The illustrated embodiment of FIG. 4 shows four servers capable of communicating with projector 100 via SAN 410. In other embodiments, Applicants' apparatus includes fewer than four servers capable of communicating with projector 100 via SAN 410. In still other embodiments, Applicants' apparatus includes more than four servers capable of communicating with projector 100 via SAN 410.

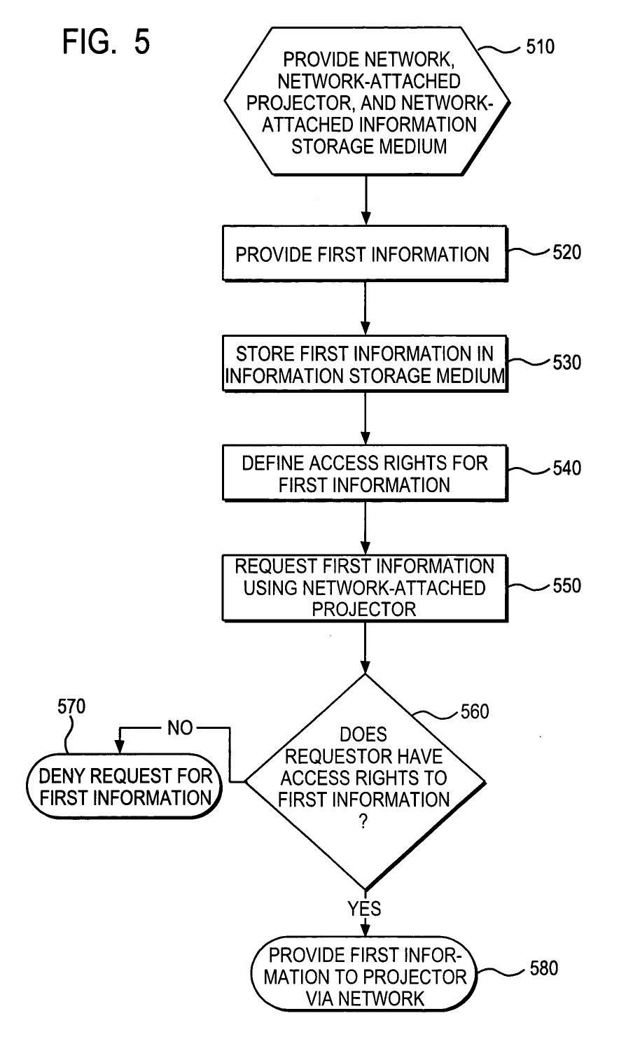

Applicants' invention includes a method to access information using Applicants' projector. Referring now to FIG. 5, in step 510 Applicants' method provides a projector, such as for example Applicants' projector 100 (FIGS. 1, 2, 3, 4), and an information storage medium comprising first information, such as for example information storage medium 242 (FIG. 2) having first information 250 (FIG. 2) written thereto, wherein that projector is capable of communicating with that information storage medium via a communication link, such as for example communication link 180.

In step 520, Applicants' method provides first information, such as for example first information 250. First information 250 comprises one or more datasets. In certain embodiments, those one or more datasets comprise, for example, one or more text documents. In certain embodiments, those one or more datasets comprise, for example, one or more images. In certain embodiments, those one or more datasets comprise, for example, one or more text documents in combination one or more images. In certain embodiments, those one or more datasets comprise, for example, one or more Microsoft Power Point presentations. In certain embodiments, those one or more datasets comprise, for example, one or more Lotus Freelance Graphics presentations. In certain embodiments, those one or more datasets comprise, for example, one or more Lotus Notes presentations.

In certain embodiments, step 520 is performed by one or more natural persons. In certain embodiments, those one or more natural persons comprise the author(s) under 17 U.S.C. § 201 of the first information provided in step 520. In other embodiments, the first information of step 520 comprises a “work made for hire” under 17 U.S.C. §§ 101, 201. Step 520 may be performed prior to step 510.

In step 530, Applicants' method writes the first information of step 520 to the information storage medium of step 510, such as for example information storage medium 242. In certain embodiments, information storage medium 242 is disposed in a computing device, such as for example computing device 200. In these embodiments, step 530 is performed by a processor, such as for example processor 220 (FIG. 2), disposed in that computing device.

In step 540, Applicants' method defines access rights for the first information provided in step 520, and written to the information storage medium in step 530. In certain embodiments, step 540 precedes step 530. In certain embodiments, step 540 is performed by a natural person. In certain embodiments, step 540 is performed by a processor, such as processor 220.

In certain embodiments, step 540 includes assigning a password for access to the first information. In certain embodiments, step 540 includes defining those access rights to include a specified time interval. In certain embodiments, step 540 includes defining those access rights to include a specified network address In certain embodiments, step 540 includes defining those access rights to include a specified geographical location.

In step 550, Applicants' method receives a request from the projector of step 510 for access to the first information provided in step 520. In certain embodiments, the request of step 550 is made by a natural person using data input device 170 (FIG. 1). In certain embodiments, the request of step 550 is made by a processor disposed within the requesting projector, such as for example processor 120 (FIG. 1).

In certain embodiments, the request of step 550 includes a password. In certain embodiments, the request of step 550 includes the time that request is made. In certain embodiments, the request of step 550 includes a network address from which the request is made. In certain embodiments, the request of step 550 includes the geographic location from which the request is made.

In step 560, Applicants' method determines if the requester of step 550 has access rights to the first information. In certain embodiments, step 560 includes determining if the request of step 550 includes the assigned password of step 540. In certain embodiments, step 560 includes determining if the request of step 550 was made within a specified time interval. In certain embodiments, step 560 includes determining if the request of step 550 was made using a device having a specified network address. In certain embodiments, the step 560 includes determining if the request of step 550 was made using a device located at a specified geographical location.

In certain embodiments, step 560 is performed by a processor, such as processor 210 (FIG. 2), disposed in a computing device, such as computing device 200 (FIG. 2), which comprises the requested first information, such as first information 250 (FIGS. 2, 4). In certain embodiments, step 560 is performed by a computing device, such as for example computing device 390 (FIG. 4) capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4). In certain embodiments, step 560 is performed by a NASD, such as for example NASD 420 (FIG. 4), capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4).

If Applicants' method determines in step 560 that the requestor making the request of step 550 has access rights to the first information of step 520, then the method transitions from step 560 to step 580 wherein the method provides that first information to the projector of step 510.

In certain embodiments, step 580 is performed by a processor, such as processor 210 (FIG. 2), disposed in a computing device, such as computing device 200 (FIG. 2), which comprises the requested first information, such as first information 250 (FIGS. 2, 4). In certain embodiments, step 580 is performed by a computing device, such as for example computing device 390 (FIG. 4) capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4). In certain embodiments, step 580 is performed by a NASD, such as for example NASD 420 (FIG. 4), capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4).

If Applicants' method determines in step 560 that the requestor making the request of step 550 does not have access rights to the requested first information, then Applicants' method transitions from step 560 to step 570 wherein the method denies the request for access to the first information. In certain embodiments, step 570 is performed by a processor, such as processor 210 (FIG. 2), disposed in a computing device, such as computing device 200 (FIG. 2), which comprises the requested first information, such as first information 250 (FIGS. 2, 4). In certain embodiments, step 570 is performed by a computing device, such as for example computing device 390 (FIG. 4) capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4). In certain embodiments, step 570 is performed by a NASD, such as for example NASD 420 (FIG. 4), capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4).

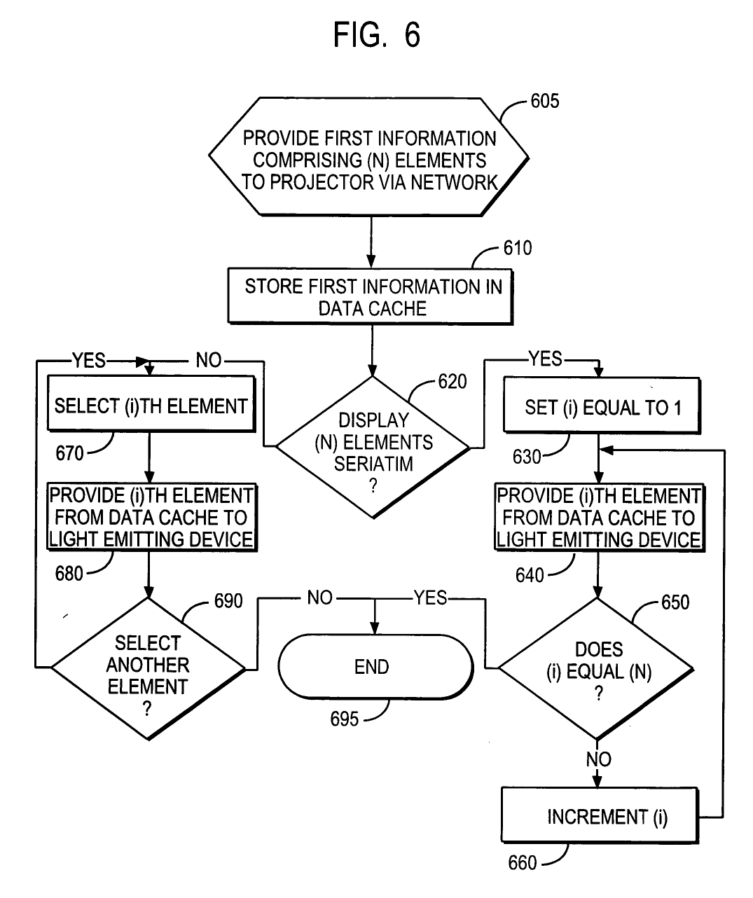

In certain embodiments, Applicants' method includes the steps recited in FIG. 6. Referring now to FIG. 6, in step 605 the method provides first information comprising (N) elements to a projector, such as for example Applicants' projector 100, via a communication link, such as for example communication link 180 (FIGS. 1, 2, 3, 4). In certain embodiments of Applicants' method, step 605 comprises step 580 recited in FIG. 5.

In certain embodiments, step 605 is performed by a processor, such as processor 210 (FIG. 2), disposed in a computing device, such as computing device 200 (FIG. 2), which comprises the requested first information, such as first information 250 (FIGS. 2, 4). In certain embodiments, step 605 is performed by a computing device, such as for example computing device 390 (FIG. 4) capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4). In certain embodiments, step 605 is performed by a NASD, such as for example NASD 420 (FIG. 4), capable of communicating with a SAN, such as SAN 410 (FIG. 4), where that SAN is also capable of communicating with the requesting device, such as for example projector 100 (FIGS. 1, 2, 3, 4), and where that SAN is further capable of communicating with a server, such as server 310 (FIGS. 3, 4), comprising the requested first information, such as first information 250 (FIGS. 2, 4).

In step 610, the first information provided in step 605 is written to a data cache, such as for example data cache 140 (FIG. 1), disposed in the projector, such as projector 100 (FIG. 1). In certain embodiments, step 610 is performed by a processor disposed within the projector, such as processor 110 (FIG. 1). In step 620, Applicants' method determines whether to display the (N) elements of the first information sequentially, i.e. seriatim. In certain embodiments, step 620 is performed by a processor disposed within the projector, such as processor 110 (FIG. 1). In certain embodiments, step 620 is performed by a user via a data input device, such as for example data input device 170 (FIG. 1).

If the method elects to display the (N) elements sequentially, then the method transitions from step 620 to step 630 wherein the method sets (i) to 1. The method transitions from step 630 to step 640 wherein the method provides the (i)th element, initially the first element, from the data cache to the light projecting device, such as device 160 (FIG. 1). Further in step 640, the light projecting device forms a visual display, i.e. the (i)th element of second information, from the (i)th element of first information, and projects that (i)th element of second information onto a selected surface, such as for example a screen, a wall, and the like.

Applicants' method transitions from step 640 to step 650 wherein the method determines if all (N) elements of the first information have been provided to the light projecting device, i.e. if (i) equals (N). In certain embodiments, step 650 is performed by a processor disposed within the projector, such as processor 110 (FIG. 1). If Applicants' method determines in step 650 that (i) equals (N), then the method transitions from step 650 to step 695 and ends. Alternatively, if all (N) elements have not been provided to the light projecting device and displayed, then the method transitions from step 650 to step 660 wherein the method increments (i). In certain embodiments, step 660 is performed by a processor disposed within the projector, such as processor 110 (FIG. 1). Applicants' method transitions from step 660 to step 640 and continues as described herein.

If Applicants' method determines in step 620 that the (N) elements of first information are not to be provided to the light projecting device sequentially, then the method transitions from step 620 to step 670 wherein the method selects the (i)th element. In certain embodiments, step 670 is performed by a user via a data input device, such as data input device 170 (FIG. 1).

The method transitions from step 670 to step 680 wherein the method provides the (i)th element, i.e. the element selected in step 670, from the data cache to the light projecting device, such as device 160 (FIG. 1). Further in step 680, the light projecting device forms a visual display, i.e. the (i)th element of second information, from the (i)th element of first information, and projects that (i)th element of second information onto a selected surface, such as for example a screen, a wall, and the like.

Applicants' method transitions from step 680 to step 690 wherein the method determines whether to select another of the (N) elements of first information. In certain embodiments, step 690 is performed by a user via a data input device, such as data input device 170 (FIG. 1).

If the user elects in step 690 to select another element, then the method transitions from step 690 to step 670 and continues as described herein. Alternatively, if the user elects in step 690 not to select another element, then the method transitions from step 690 to step 695 and ends.

The embodiments of Applicants' method recited in FIGS. 5 and/or 6, may be implemented separately. Moreover, in certain embodiments, individual steps recited in FIGS. 5 and/or 6, may be combined, eliminated, or reordered.

While the preferred embodiments of the present invention have been illustrated in detail, it should be apparent that modifications and adaptations to those embodiments may occur to one skilled in the art without departing from the scope of the present invention as set forth in the following claims.

We claim:

1. A projector, comprising:
a light projecting device;
a processor interconnected with said light projecting device;
a network interface interconnected with said processor;
a non-volatile memory device; and
instructions to operate said projector using said processor written to said memory device.

2. The projector of claim 1, wherein said instructions comprise an operating system.

3. The projector of claim 1, further comprising a data cache, wherein said data cache is interconnected with said network interface.

4. The projector of claim 1, further comprising a GPS device, wherein said GPS device is interconnected with said network interface.

5. The projector of claim 1, further comprising a data input device.

6. The projector of claim 5, wherein said data input device comprises a hand-held device, and wherein said data input device is capable of wireless communication with said projector.

7. A method to authenticate a local interface for a network attached projector, comprising the steps of:
providing a projector comprising a light projecting device, a processor interconnected with said light projecting device, a network interface interconnected with said processor, a non-volatile memory device interconnected with said processor, and microcode written to said memory device;
supplying an information storage medium comprising first information;
supplying a communication link capable of communicating with said projector and with said information storage medium;
defining access rights for said first information;
requesting by a requester via said projector said first information;
determining if said requestor has access rights to said first information;
operative if said requestor has access rights to said first information, providing said first information to said projector;
operative if said requestor does not have access rights to said first information, denying access to said first information.

8. The method of claim 7, wherein said providing first information step further comprises:
providing said first information to said data cache;
storing said first information in said data cache;
providing said first information from said cache to said light projecting device.

9. The method of claim 8, wherein said providing first information step further comprises providing first information comprising (N) elements, said method further comprising the steps of:
setting (i) equal to 1;
providing the (i)th element from said data cache to said light projecting device;
incrementing (i) by 1;
repeating said providing step and said incrementing step until the (N)th element has been provided from said data cache to said light projecting device.

10. The method of claim 8, wherein said providing first information step further comprises providing first information comprising (N) elements, said method further comprising the steps of:
selecting a value for (i), wherein (i) is greater than or equal to 1 and less than or equal to (N);
providing said value of (i) to said projector using said data input device;
providing the (i)th element from said data cache to said light projecting device.

11. The method of claim 7, further comprising the step of providing a computing device, wherein said information storage medium is disposed in said computing device, and wherein said determining step is performed by said computing device.

12. The method of claim 11, further comprising the step of providing a storage attached network, wherein said storage attached network is capable of communicating with said projector, and wherein said storage attached network is capable of communicating with said computing device.

13. The method of claim 7, further comprising the steps of:
providing a computing device;
providing a providing a storage attached network, wherein said storage attached network is capable of communicating with said projector, and wherein said storage attached network is capable of communicating with said computing device, and wherein said storage attached network is capable of communicating with said information storage medium; and
wherein said determining step is performed by said computing device.

14. The method of claim 7, further comprising the steps of:
creating an LDAP directory on said information storage medium;
disposing said first information in said LDAP directory;
requesting access to said first information using an LDAP protocol.

15. The method of claim 7, wherein said supplying a communication link step further comprises supplying a wireless network compliant with the IEEE Specification.

16. The method of claim 7, wherein:
said defining step further comprises defining said access rights to include a password; and
said determining step further comprises determining if said request includes said password.

17. The method of claim 7, wherein:
said defining step further comprises defining said access rights to include a time interval; and
said determining step further comprises determining if said request is received within said time interval.

18. The method of claim 7, wherein:
said network interface device comprises a first network address;
said defining step further comprises defining said access rights to include a specified network address; and
said determining step further comprises determining if said first network address comprises said specified network address.

19. The method of claim 7, wherein said supplying a projector step further comprises supplying a projector comprising a GPS device, said method further comprising the steps of:
determining the present geographical location of said projector when making said request; and
providing said present geographical location with said request.

20. The method of claim 19, wherein:
said defining step further comprises defining said access rights to include a specified geographical location; and
said determining step further comprises determining if said present geographical location comprises said specified geographical location.
